(19) United States
(12) Patent Application Publication
(10) Pub. No.: US 2014/0299778 A1
(43) Pub. Date: Oct. 9, 2014

(54) MEaSURENOW

(71) Applicant: Charles Mallory Dean, Torrance, CA (US)

(72) Inventor: Charles Mallory Dean, Torrance, CA (US)

(21) Appl. No.: 14/259,743

(22) Filed: Apr. 23, 2014

(51) Int. Cl. G01N 21/33; G01N 21/27

(52) U.S. Cl. CPC G01N 21/33; G01N 21/27
USPC 250/372

(57) ABSTRACT

The need for an instant handheld analysis of cannabis products has been in demand for years from the consumer/dispensary level and grower's quality control. Recent developments in sensitivity and detection devices have transformed the bulky tabletop industry into a personal measurement device. This device consists of a sample cell slot that is an opening used to insert the sealed, extracted, sample cell (see FIG. 1). The extraction cell (see FIG. 2) is a Borosillate material that opens at the top to allow small size sample to be inserted, and mixed into a small amount of solvent. The extracted solvent is then transferred to a polyethylene sample cell (see FIG. 3) and inserted into the device. Once the sample cell is inserted in the device, the user presses the “Measure” button and the THC concentration is shown on the display after a number of seconds.

### BACKGROUND

This is a handheld device that takes a known, small amount of marijuana (about 40 micrograms), extracts the active components with a small amount of solvent (½ ml), and reads the amount directly from a miniature hand held uv detector. An internal led lamp at a specific wavelength shines through sample cell and the resulting absorbance is read by a wavelength specific detector.

This device is intended to give the user a quick accurate check of the concentration of THC and the analogous active compounds in cannabis. It provides a new, and more compact, and faster way to determine THC content.

### SUMMARY

THC absorbs light in the 273-310 nm wavelength region. This is a unique signal that can be used to determine content and concentration. A small calibration response factor is saved in the firmware of the device. That response is compared to a “sample” response acquired by the user. That response and the calculated concentration are read to the display.

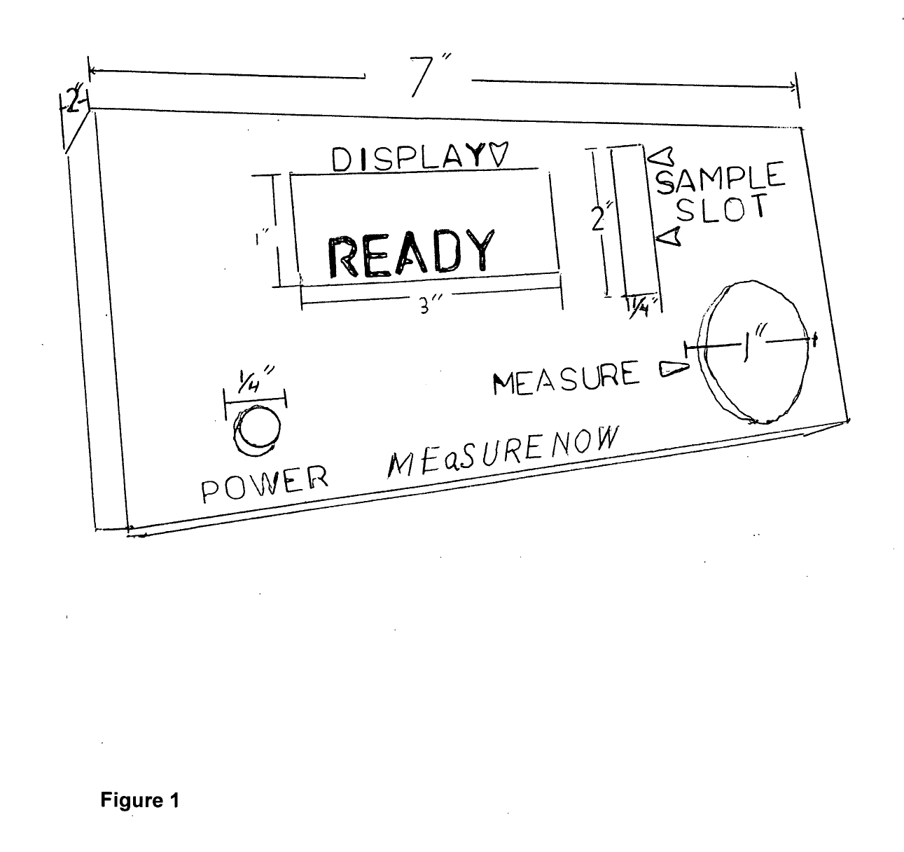

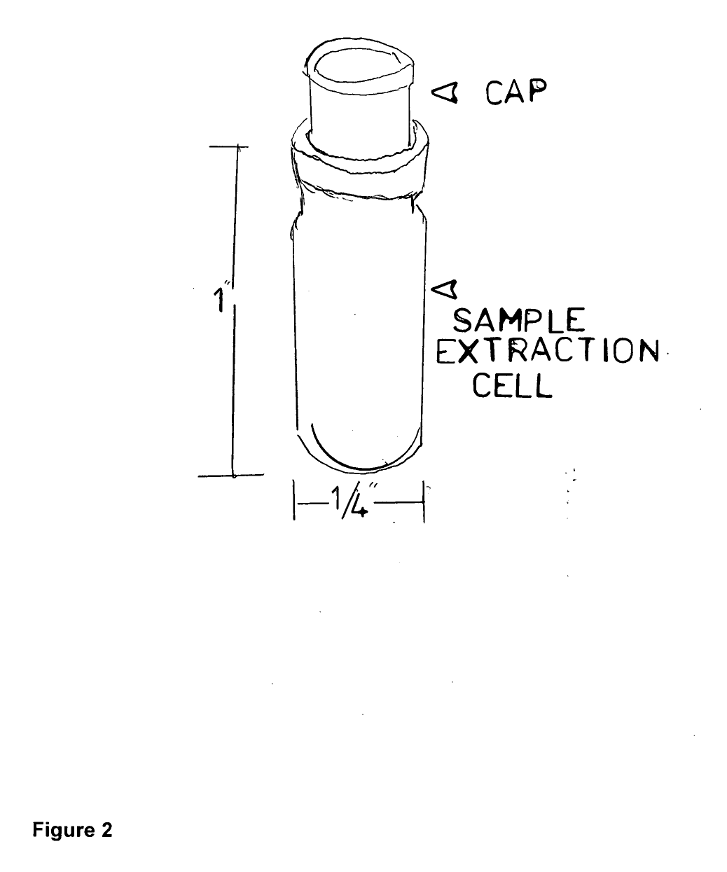

The extraction cells are single use extraction devices. The sample cell is also intended as single use. The extraction cell top is a hollow “cup” that is used to measure a specific amount of sample (see FIG. 2). Once the sample is measured, it can be emptied into the extraction cell. The extraction cell is capped, and then inverted 5-10 times to complete the extraction process. Then the extraction cell contents are transferred to the sample cell. The sample cell is sealed, and then placed into the sample slot on the device (see FIG. 1). Once the “Measure” button is depressed a sample reading from the detector is saved to the program and compared to a standard response curve. The result from the comparison is displayed as a percentage of the sample. Then whole process is complete in less than ten minutes.

### DETAILED DESCRIPTION OF THE INVENTION

The MEaSURENOW device measures approximately 4 inches wide×2 inches wide×7 inches long.

This invention uses a 9 volt battery as a power source to supply voltage to drive the 24 volt ultraviolet detector and the 6 volt, 10 milliamp Ultraviolet led light source in the 280 nm wavelength range. The display is a standard backlit 5 volt display. A microcontroller step up transformer is used to raise the necessary voltages. The 18F1320 microchip is used for the program algorithm and calculation storage. The algorithm used in concentration calculations takes into account the solubility of THC in Ethanol, and is correlated to gas chromatography analyses.

The sample cell is a 2″×2″ polyethylene film with a press fit seal enclosing the top. The extracted sample is poured into this cell before analysis. A sample “film” is formed between the polyethylene layers of the sample cell, the light from the led then passes through on the way to the detector. This is a onetime use cell. It comes in an extraction kit with the extraction cell picture in FIG. 2

Before analysis, the MEaSURENOW device must be allowed to warm up for 2 minutes. When the display comes on, there is a short message “Warming up”, then Ready”. The user then places the extracted sample and sample cell into the cell cavity and presses the “Measure” button. After a small wait time, the total THC, CBD, CBN concentration is shown as weight percent on the display (“xxx % THC”).

The “Measure” button activates, when pressed, the led uv source lamp and lamp timer circuit. This lamp is only allowed to stay on for 15-20 seconds, only long enough for the detector to develop a signal, then the lamp shuts off. Additional measurements can be taken on the same sample. The device only measures what is in the cell cavity.

If the reading is too low, the message “Sample inserted? ” may show on the display. Alternatively, if the sample is too dark, the message “not enough light . . . ” is shown. The sample can be re-analyzed if desired. Once the analysis is complete, the sample cell may be removed in preparation for the next sample. The power circuit is also on a timer and shuts the device down after ten minutes of inactivity.

### BRIEF DESCRIPTION OF FIG. 1

### MEaSURENOW

The “POWER” button (lower left) initializes the device and the display.

The “SAMPLE SLOT” (upper right) is the location on the device where the sample cell is placed for measurement. It is also used as a guide to insert the sample cell between the source lamp and the detector.

The “MEASURE” button (lower right) is pressed when sample is inserted into the sample slot. It allows the light to be detected and the calculation is displayed. Also starts “lamp on” timer when pressed. The device is designed with an auto shutoff after 10 minutes of inactivity.

The “Display” shows the current status of the device (measuring, warming up, results, etc)

### BRIEF DESCRIPTION OF FIG. 2

### Sample Extraction Cell

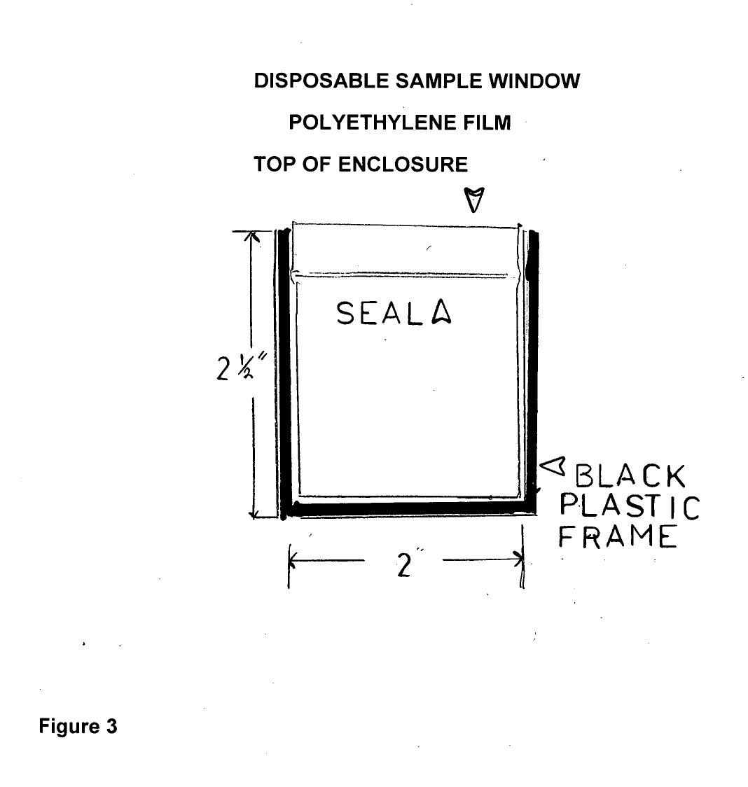

This is an example of the type of sample extraction cell used in the MEaSURENOW device. The top of the cap is used to measure approximately 30-40 mg of sample; this improves the accuracy of the device. The disposable sealed sample extraction cell comes with ½ ml of Ethanol. The user simply removes the seal, takes off the top, measures the sample, places the sample in the cell, and inverts the cell to extract the THC. The contents are then poured into the cell window (see FIG. 3) then inserted into the sample slot of the device. (see FIG. 1)

### BRIEF DESCRIPTION OF FIG. 3

### Sample Cell

This is an example of the type of sample cell used in the MEaSURENOW device. The top of the cell is a one-time use re-closable polyethylene bag. The content of the extraction cell (½ ml Ethanol) is poured into the sealable cell. This creates a thin film in the cell that can be penetrated by the small uv source lamp. The cell is then inserted into the sample slot on the device (see FIG. 1).

This invention claims:

1. This is small optical device can determine total THC concentration in an extracted sample Ultraviolet absorbance and detection at a specific band of wavelengths.

2. An instrument, according to claim 1, that is simple and safe to use. The user needs no prior knowledge of analytical chemistry. Simply, extract the sample in the cell, insert the sample cell into the cell cavity of the device, press the “measure” button and read the concentration of THC, CBD, and CBN as a total concentration on the display.( See FIG. 1).

3. The invention in claim 1 utilizes single use, disposable, 1.5 ml glass ampoules as an extraction tool and a simple sample measurement cell (see FIGS. 2 and 3).

4. The invention in claim one is capable of analyzing other concentrates and food derivatives containing cannabis.

5. The device in claim 1 is powered by a 9 v battery.
